(19) United States
(12) Patent Application Publication
(10) Pub. No.: US 2026/0002658 A1
(43) Pub. Date: Jan. 1, 2026

(54) DYNAMIC LIGHT FOR A DRIVING SIMULATOR

(71) Applicant: FCA US LLC, Auburn Hills, MI (US)

(72) Inventors: Matthew A. Taylor, Auburn Hills, MI (US); Brian P. Minnebo, Auburn Hills, MI (US)

(21) Appl. No.: 18/758,406

(22) Filed: Jun. 28, 2024

(51) Int. Cl. F21V 14/02; F21S 8/04

(52) U.S. Cl. CPC F21V 14/02; F21S 8/046

(57) ABSTRACT

A driving simulator includes a control system including visual content, a display connected to the control system to display the visual content, a simulated vehicle environment, and a dynamic light system including a movable light source arranged to simulate an environmental light of the visual content. The movable light source projects light toward the simulated vehicle environment at a varying intensity and at different angles to simulate the environmental light when the environmental light is shown in different positions on the display.

### FIELD

The present disclosure relates to a driving simulator having one or more movable or dynamic lights.

### BACKGROUND

Driving simulators are located in dark rooms to improve the appearance of a simulator display and to avoid “washing out” the display with competing light. This leaves the user environment and driver controls without much, if any, illumination and thereby frustrates user interaction with the controls and things in the area of the user. Simply shining any light into the simulated driving environment, such as via an overhead light in the interior of a simulator, is not realistic and does not enable testing of the systems with different lights at different angles that replicate real-world conditions, such as driving in sunlight, streetlights, other car headlights, and so on.

### SUMMARY

In at least some implementations, a driving simulator includes a control system including visual content, a display connected to the control system to display the visual content, a simulated vehicle environment, and a dynamic light system including a movable light source arranged to simulate an environmental light of the visual content. The movable light source projects light toward the simulated vehicle environment at a varying intensity and at different angles to simulate the environmental light when the environmental light is shown in different positions on the display.

In at least some implementations, the movable light source includes at least one light that is movable relative to the display. In at least some implementations, the at least one light is arranged between the display and the simulated vehicle environment. In at least some implementations, the display is arranged between the at least one light and the simulated vehicle environment, and the display is translucent to permit projection of light from the at least one light through the display and onto the simulated vehicle environment.

In at least some implementations, the movable light source includes multiple lights and wherein less than all of the multiple lights are used to simulate the environmental light at one time. In at least some implementations, movement of the environmental light is simulated by changing which of the less than all of the multiple lights are used. In at least some implementations, multiple ones of the lights are used to simulate one environmental light source.

In at least some implementations, the simulated vehicle environment includes a housing with an interior arranged to simulate a passenger compartment of a vehicle, the housing has a windshield and one or more other windows through which light enters the interior.

In at least some implementations, the simulated vehicle environment is movable relative to the display to change the angle of the simulated vehicle environment relative to the display.

In at least some implementations, the movable light source includes an array of lights carried by a support that is movable relative to the display. In at least some implementations, the support is moved by an actuator that is controlled by the control system. In at least some implementations, the support is one or more of rotatable about an axis, movable in a first direction along the axis and tiltable relative to the axis.

In at least some implementations, the movable light source is controlled by the control system to vary the brightness and angle at which the movable light source projects light.

In at least some implementations, a driving simulator includes a control system including a processor and memory programming that includes visual content, a display connected to the control system to display the visual content at a first light output level, the visual content including environmental scenery and one or more environmental lights, a housing with an interior arranged to simulate at least part of a vehicle passenger compartment, a seat within the interior and one or more windows through which the display is visible from the interior and a dynamic light system. The light system includes a movable light source arranged to project light at a second light output level that is greater than the first light output level. The movable light source projects light toward the housing and the movable light source is movable to project light at different angles to simulate the one or more environmental lights when the one or more environmental lights are in different positions on the display.

In at least some implementations, the movable light source is connected to an actuator that moves the movable light source and wherein the control system includes instructions to control the actuator in accordance with movement of the one or more environmental lights.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a driving simulator for a vehicle, the simulator has one or more lights to simulate environmental lighting;

FIG. 2 is a view similar to FIG. 1 and illustrating the lights moved to simulate light projected at the vehicle at a different angle;

FIG. 3 is diagrammatic view of a driving simulator wherein the lights are arranged behind a viewing screen, with a light show in a position at which the sun is shown on the screen;

FIG. 4 is a view similar to FIG. 3 with the sun shown at a second location and with the light moved to simulate the sun in the second location; and

FIG. 5 is a view similar to FIG. 3 showing multiple lights behind the screen to simulate lights at different areas of the screen, and showing two lights illuminated to simulate headlights of an oncoming vehicle shown on the screen.

### DETAILED DESCRIPTION

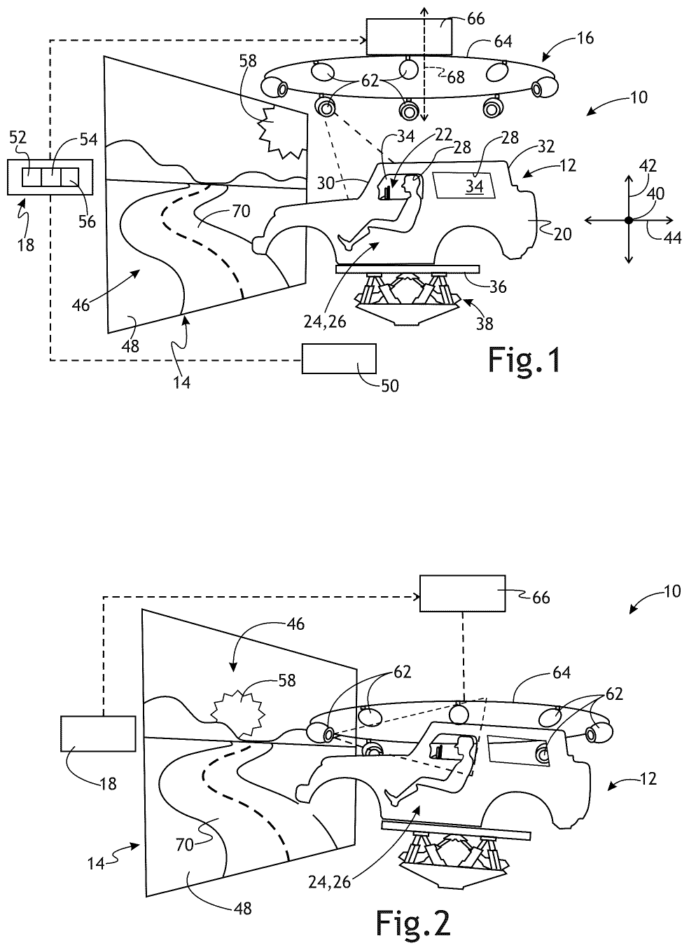

Referring in more detail to the drawings, FIG. 1 illustrates a driving simulator 10 having a simulated vehicle environment 12, a display 14, a dynamic light system 16 and a control system 18. The simulated vehicle environment 12 may include a housing 20 or structure with driving controls 22, such as steering, throttle and brake controls that may be designed to simulate those controls in a real vehicle. The housing 20 may also include an interior 24 that may be designed to simulate part or all of a passenger compartment 26 of a real vehicle. In at least some implementations, the interior 24 may include one or more seats, interior trim components, a human-machine interface which may be an infotainment system of the simulated vehicle and other electronics and user controllable devices (e.g. switches, knobs, buttons, touchscreens, and the like). Thus, in at least some implementations, the simulated vehicle environment 12 includes not only simulated driving controls 22 associated with driving a vehicle, but may also include other vehicle devices to enable simulation of user interactions with a vehicle.

Further, the housing 20 includes one or more openings 28 which may include windows, like a windshield 30 at a front end of the passenger compartment 26, a rear window 32 at a read end of the vehicle or passenger compartment 26 and one or more side/door windows 34. The housing 20 and windows 30-34 may be arranged to provide realistic sight lines into and out of the simulated vehicle 12, and may permit the ingress and egress of light relative to the passenger compartment 26.

The simulated vehicle 12 (e.g. the housing 20) may be mounted to a platform 36 that is driven for movement about one or more axes by a first actuator 38. The first actuator 38 may include one or more motors or powered cylinders (e.g. pneumatic or hydraulic) arranged to move the platform 36 and housing 20. For example: 1) the first actuator 38 may rotate the platform 36 about a cross-car axis 40 which causes a front end of the vehicle to move upward or downward, in a vertical direction, which may simulate driving up or down an incline; 2) the first actuator 38 may rotate the platform 36 about a vertical axis 42 which causes the front end of the vehicle to move left or right in the cross-car direction and which may simulate forces experienced when a vehicle is turned; and 3) the first actuator 38 may rotate the platform 36 about a fore-aft axis 44 which causes the left/right sides to move upward or downward and which may simulate driving along an embankment or the like. The movements can be combined to define a wide range of movements and simulate a wide range of forces for a more realistic simulator driving experience.

To simulate an environment in which the vehicle 12 is being “driven”, the display 14 may be arranged to show visual content 46 to a person seated within the passenger compartment 26. The visual content 46 may be changed in response to actuation of the driving controls 22 in a manner similar to how the view from the passenger compartment 26 of an actual environment would change with a vehicle actually being driven. The display 14 may be of any type, including but not limited to LCD, LED, OLED, QLED, plasma and the like, and may include one or more screens 48 (e.g. one or more monitors) or a front or rear projection system including a projector and a screen 48 on which an image is projected from the projector 50. The display 14 may be arranged in a planar format in front of the simulated vehicle 12, such as is shown in the drawings, or a curved or partly curved format to wrap around part or all of the simulated vehicle 12, as desired.

To provide and control movement of the visual content 46, the display 14 may be connected to a control system 18. The control system 18 may include one or more processors 52 and memory 54 that includes one or more programs 56 and/or instructions for the visual content 46. The control system 18 may be part of the simulated vehicle 12, for example part of one or more electronic control units of the vehicle, or it may be separately provided, such as by a computer connected to the display 14 by a wired or wireless connection.

The control system 18 is also connected to the vehicle to receive outputs representative of actuation of the driving controls 22. In this way, if a user actuates a driving control 22 (e.g. the throttle control which may be an accelerator pedal) the visual content 46 is changed to simulate acceleration of the vehicle, and realistic changes to the visual content 46 occurs if the user actuates the brake control and steering control as well.

Lighting can play a part in making the simulated vehicle environment 12 and simulated driving experience more realistic. Both interior lighting, within the passenger compartment 26 and provided from interior light sources, and external or environmental lighting 58 can be provided. As noted above, the simulated vehicle 12 may include realistic or actual vehicle interior components, including electronic devices and lights, and these may be illuminated or provide illumination as they would in a real vehicle, if desired. Further, environmental lighting 58 may be provided at least in part by the dynamic light system 16.

The dynamic light system 16 includes at least one movable light source 62 arranged to simulate an environmental light 58 that complements or is part of the visual content 46. For example, the visual content 46 may include a city scene with one or more streetlights, other vehicles, the sun or moon, etc. During simulated driving, these environmental lights 58 will move relative to the vehicle as if the vehicle were moving relative to them in the real world. Further, rather than simply being displayed on the screen 48 with a brightness or output intensity similar to the rest of the simulated environment/visual content 46, the movable light source(s) or lights 62 project(s) light toward the simulated vehicle environment 12 and this may be done at a varying intensity and at different angles to simulate different positions and angles of the environmental light sources 58. For example, one or more lights 62 may simulate the sun and the position of the lights 62 that are projecting simulated sun light toward the vehicle 12 can be changed to simulate the sun at different times of day/positions in the sky. This will provide sunlight through the windows and into the passenger compartment 26 at different angles and intensity/brightness. Among other things, this can be helpful to determine how the components of the passenger compartment 26 appear and how user interaction with the components is affected in different lighting conditions.

In the example of FIG. 1, the dynamic light system 16 includes a light support 64, multiple lights 62 carried by the support 64, and a light actuator 66 coupled to the support 64 to move the support relative to the simulated vehicle 12. The support 64 may be connected to the housing 20, or separate from the housing 20 (e.g. supported within a room that includes the simulator 10). In the example shown, the support 64 is annular and the multiple lights 62 are spaced apart circumferentially about the support 64. Of course, other arrangements may be used. Each light 62 may be separately driven (i.e. turned on) so that one or more lights 62 are actuated and project light at any given time. The light actuator 66 is connected to the control system 18 and may include one or more powered cylinders or motors arranged to move the support 64 as desired. The support 64 may be rotated about a central axis 68, raised or lowered along the axis, and tilted in any desired direction or plane, as desired.

In FIG. 1, a single light 62 is actuated to project light in the direction and at an angle representative of the sun 58 which is shown in the upper right-hand corner of the display 14. In FIG. 2, the support 54 has been lowered and the light 62 projecting light toward the vehicle simulates light from the sun 58 which is shown lower, and just above a simulated road 70 on the display 14, and more directly toward the eyes of the simulator user seated in the passenger compartment 26/interior 24. While only the sun is shown as an environmental light 58 that would project light toward the simulated vehicle 12, the visual content 46 may include other lights, as noted above.

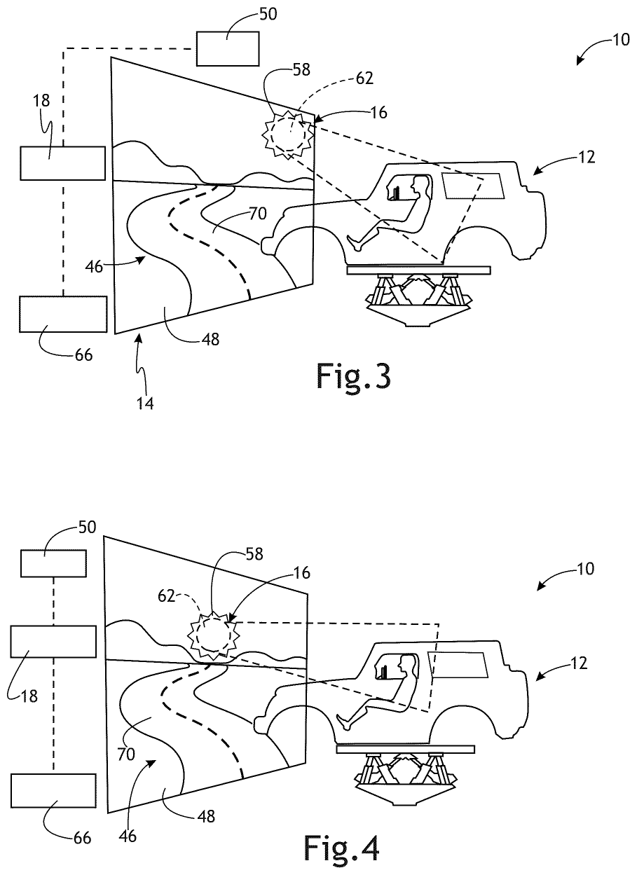

In the example of FIGS. 3 and 4, the visual content 46 includes a representation of the sun 58 that is in similar positions as in FIGS. 1 and 2, respectively. In this example, the dynamic light system 16 includes a movable light source 62 that is located behind the display screen 48, which is translucent to permit light to be projected through the screen 48. The visual content 46 may be provided on the screen 48 by a projector 50 that is located in front of the screen 48 (i.e. on the same side of the screen 48 as the simulated vehicle 12) or behind the screen 48 with the screen 48 located between the light source 62 and the simulated vehicle 12. The light source 62 used to project the light to simulate the sun 58 may be moved by an actuator 66, as shown by comparison of FIGS. 3 and 4, or the sun 58 may be simulated in different positions by different lights 62 without physically moving any light 62, if desired. In the latter case, the movable light source 62 is defined by multiple lights 62 that are in different positions and which can be driven separately so that the location of projected light moves. In at least some implementations, the light is projected through the area of the screen 48 on which the simulated environmental light source 58 is shown during use of the simulator 10.

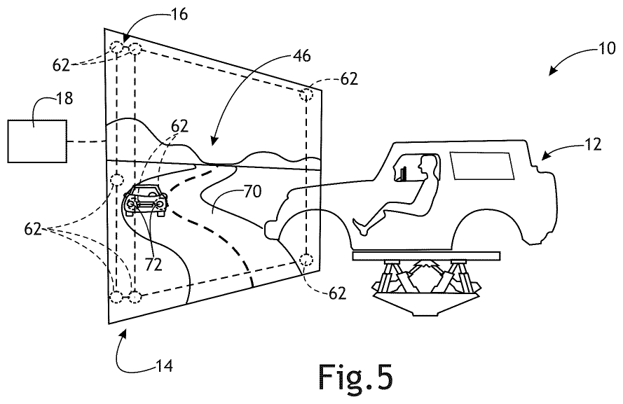

In FIG. 5, the dynamic light system 16 includes a movable light source 62 that is located behind the display screen 48 as in FIGS. 3 and 4. The movable light source 62 in this example includes multiple fixed lights 62 arranged in any desired manner, such as but not limited to an evenly spaced matrix or array. Environmental lights 58 in different positions on the screen 48 can be simulated by actuating one or more lights in that area of the screen 48 to project light through that area of the screen 48. The lights 62 are shown diagrammatically by broken-line circles in FIG. 5, and only a few lights 62 are shown. It should be understood that lights 62 may be provided in any number and size, and adjacent to any or all portions of the screen 48, as desired.

In the example of FIG. 5, the headlights 72 of an oncoming vehicle are two environmental light sources in the visual content 46, and corresponding ones of the lights 62 are actuated to project light from the area of the screen 48 including the headlights 72. Each light source 62 may have a single light, e.g. an LED, and may be turned on or off, and the color and brightness may be adjusted. One or more of the light sources 62 of the dynamic light system 16 could instead include multiple lights, e.g. multiple LEDs, and all or just one or more of the LEDs may be actuated and the color and brightness may be adjusted collectively or individually. This may facilitate changing the size or shape or brightness, or all of these characteristics, of the light projected therefrom. This may also facilitate simulating movement of an environmental light source 58 as the position and size of the environmental light source 58 may change with simulated movement of the vehicle relative thereto. Movement may thus be simulated by changing the light sources 62 used to project light, by changing which of multiple lights 62 of a light source are actuated to project light or a combination of both. Thus, the movable light source 62 can include multiple lights 62, less than all of the multiple lights 62 can be used at any one time to simulate the environmental light, and movement of the environmental light 58 can be simulated by changing which of the less than all of the multiple lights 62 are used.

In at least some implementations, the display 14 reflects or outputs light at a first light level and the dynamic light system 16, including one or more light sources 62, projects light at a second light level that is greater than the first light level. In at least some implementations, the light source 62 projects light at a brightness that is greater than the image/pixels representing the sun on the display 14, which are displayed at a brightness and color commensurate with the rest of scene shown on the display 14.

The light source 62 can project light directly at and into the cabin or passenger compartment 26 of a driving simulator 10. In at least some implementations, the primary purpose of the light source 62 is to provide direct light at the passenger compartment 26 and vehicle environment 12, whereas the primary purpose of the lighting for the display is so that the features being displayed can be clearly seen and any lighting of the vehicle environment 12 is indirect and a secondary effect. When synchronized with the environmental light sources 58 of the displayed visual content 46, the light source 62 can replicate the light sources a driver might expect from driving in the real world (i.e., sunlight, moonlight, streetlights, etc.). The light source(s) 62 is/are dynamic, may be capable of changing position, intensity, and color, providing deeper immersion to the simulator driver/operator, thus creating a more accurate and believable simulated environment. The simulator 10 may be used not only for testing production drive systems, but also for HMI/infotainment system testing by user interaction with the systems in simulated real-world conditions and lighting. The system may also be used to test user interaction and ease of use of various other devices and components within a vehicle passenger compartment 26, such as to test different locations and types of user actuated devices/interfaces. Further, the projected light can provide light within the passenger compartment 26 that better simulates how the passenger compartment 26 would be illuminated in a real vehicle.

Previous driving simulators are located in dark rooms to improve the appearance of the display and to avoid “washing out” the display with competing light. This leaves the passenger compartment 26 and driver controls without much, if any, illumination and thereby frustrates user interaction with things in the passenger compartment 26. Simply shining any light into the passenger compartment 26, such as via an overhead light in the interior of a simulator, is not realistic and does not enable testing of the systems with different lights at different angles that replicate real-world conditions.

What is claimed is:

1. A driving simulator, comprising:
a control system including visual content;
a display connected to the control system to display the visual content;
a simulated vehicle environment; and
a dynamic light system including a movable light source arranged to simulate an environmental light of the visual content, wherein the movable light source projects light toward the simulated vehicle environment at a varying intensity and at different angles to simulate the environmental light when the environmental light is shown in different positions on the display.

2. The driving simulator of claim 1 wherein the movable light source includes at least one light that is movable relative to the display.

3. The driving simulator of claim 1 wherein the movable light source includes multiple lights and wherein less than all of the multiple lights are used to simulate the environmental light at one time.

4. The driving simulator of claim 3 wherein movement of the environmental light is simulated by changing which of the less than all of the multiple lights are used.

5. The driving simulator of claim 2 wherein the at least one light is arranged between the display and the simulated vehicle environment.

6. The driving simulator of claim 2 wherein the display is arranged between the at least one light and the simulated vehicle environment, and the display is translucent to permit projection of light from the at least one light through the display and onto the simulated vehicle environment.

7. The driving simulator of claim 3 wherein multiple ones of the lights are used to simulate one environmental light source.

8. The driving simulator of claim 1 wherein the simulated vehicle environment includes a housing with an interior arranged to simulate a passenger compartment of a vehicle, the housing has a windshield and one or more other windows through which light enters the interior.

9. The driving simulator of claim 1 wherein the simulated vehicle environment is movable relative to the display to change the angle of the simulated vehicle environment relative to the display.

10. The driving simulator of claim 1 wherein the movable light source includes an array of lights carried by a support that is movable relative to the display.

11. The driving simulator of claim 10 wherein the support is moved by an actuator that is controlled by the control system.

12. The driving simulator of claim 11 wherein the support is one or more of rotatable about an axis, movable in a first direction along the axis and tiltable relative to the axis.

13. The driving simulator of claim 1 wherein the movable light source is controlled by the control system to vary the brightness and angle at which the movable light source projects light.

14. A driving simulator, comprising:
a control system including a processor and memory programming that includes visual content;
a display connected to the control system to display the visual content at a first light output level, the visual content including environmental scenery and one or more environmental lights;
a housing with an interior arranged to simulate at least part of a vehicle passenger compartment, a seat within the interior and one or more windows through which the display is visible from the interior; and
a dynamic light system including a movable light source arranged to project light at a second light output level that is greater than the first light output level, and wherein the movable light source projects light toward the housing and the movable light source is movable to project light at different angles to simulate the one or more environmental lights when the one or more environmental lights are in different positions on the display.

15. The driving simulator of claim 14 wherein the movable light source includes at least one light that is movable relative to the display.

16. The driving simulator of claim 14 wherein the movable light source includes multiple lights and wherein less than all of the multiple lights are used to simulate the environmental light at one time.

17. The driving simulator of claim 16 wherein movement of the environmental light is simulated by changing which of the less than all of the multiple lights are used.

18. The driving simulator of claim 15 wherein the at least one light is arranged between the display and the simulated vehicle environment.

19. The driving simulator of claim 15 wherein the display is arranged between the at least one light and the simulated vehicle environment, and the display is translucent to permit projection of light from the at least one light through the display and onto the simulated vehicle environment.

20. The driving simulator of claim 14 wherein the movable light source is connected to an actuator that moves the movable light source and wherein the control system includes instructions to control the actuator in accordance with movement of the one or more environmental lights.
